(19) United States
(12) Patent Application Publication
(10) Pub. No.: US 2006/0184901 A1
(43) Pub. Date: Aug. 17, 2006

(54) COMPUTER CONTENT NAVIGATION TOOLS

(75) Inventor: Robert Dietz, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/058,807

(22) Filed: Feb. 15, 2005

(51) Int. Cl. G06F 17/00

(52) U.S. Cl. 715/855; 715/777; 715/787; 715/861

(57) ABSTRACT

Computer content navigation tools and associated methods are disclosed. One aspect of the invention is directed toward a computer-implemented method for providing content navigation information that includes displaying a navigation tool that proportionally represents a range of locations in a displayable content set. The method can further include displaying one or more anchors proximate to the navigation tool. Each anchor can correspond to a portion of the content set. The position of the anchors relative to the navigation tool can visually represent the displayable location of the corresponding portions relative to one another. In certain embodiments, the method can further include displaying a location marker proximate to the navigation tool and displaying at least one navigation arrow when a cursor is positioned proximate to a selected area of a display. When the cursor is no longer proximate to the selected area, the navigation arrow(s) can be removed.

### TECHNICAL FIELD

The following disclosure relates generally to computer content navigation tools and associated methods.

### BACKGROUND

Computer systems are capable of providing users with large amounts of information. A problem associated with this feature is that a computer monitor can only display a certain amount of information at one time. Accordingly, a user is often faced with paging or scrolling through a large number of pages or screen shots in order to locate specific pieces of information.

To aid users in paging through information, some applications provide the user with an index. An index generally consists of uniformly spaced tabs. When a user selects a tab, a portion of information associated with the tab is displayed. For example, alphabetic tabs can correspond to the first letter of names in a list and when a user selects a tab, a portion of the names corresponding to the tab can be displayed.

Other applications provide users with a scroll bar that can be used to page through information. To page through information using a typical scroll bar a user moves a scroll box relative to the scroll bar. For example, to scroll through a document in a word processing application having a scroll bar, a user can move between the front and back of the document by sliding the scroll box along the scroll bar. As the scroll box slides along the scroll bar, corresponding pages of text scroll up or down on the display. In certain applications, as the user moves the scroll box, information is provided describing the material that is being displayed. For example, a text window (e.g., next to the scroll box) might display the page number of the page that is currently being displayed. In other embodiments, the size of the scroll box can represent the relative size of the information that is currently displayed on the computer monitor compared to the total information available for display (e.g., the total size of the file or document). Even when an application provides a user with an index or scroll bar, it can be difficult and time consuming to locate specific types or pieces of information when the information includes a large number of pages or screen shots.

### SUMMARY

The present invention is directed generally toward computer content navigation tools and associated methods. One aspect of the invention is directed toward a computer-implemented method for providing content navigation information that includes displaying a navigation tool that proportionally represents a range of locations in a displayable content set. The content set can have multiple portions where each portion has a displayable location relative to the other portions. The method can further include displaying one or more anchors proximate to the navigation tool. Each anchor corresponds to a portion of the content set. The position of the anchors relative to the navigation tool visually represents the displayable location of the corresponding portions of the content set relative to one another. In other embodiments, the method can further include displaying one or more labels associated with the one or more anchors. In certain embodiments, these features can provide a user with a navigational tool that provides contextual information regarding various portions of the content set, the relative depth of information contained in the portions, and/or the position of the portions relative to one another.

Another aspect of the invention is directed generally toward a computer-implemented method for providing content navigation information that includes displaying a navigation tool representing a range of locations in a displayable content set. The method can further include displaying a location marker proximate to the navigation tool. The position of the location marker relative to the navigation tool indicates a location in the content set to be displayed. The method can still further include displaying at least one navigation arrow when a cursor is positioned proximate to one or more selected areas of a display. The navigation arrow(s) are selectable to command the location marker to move relative to the navigation tool. The method can further include removing the navigation arrow(s) when the cursor is no longer proximate to the one or more selected areas of the display.

### BRIEF DESCRIPTION OF THE DRAWINGS

FIG. 1 is a partially schematic illustration of a computing system suitable for implementing embodiments of the invention.

FIG. 2 is a flow diagram illustrating a first computer-implemented method for providing navigation information in accordance with embodiments of the invention.

FIG. 3 is a flow diagram illustrating a second computer-implemented method for providing navigation in accordance with other embodiments of the invention.

FIG. 4 is a partially schematic illustration of a navigation tool in accordance with certain embodiments of the invention.

FIG. 5 is a partially schematic illustration of a navigation tool in accordance with other embodiments of the invention.

FIG. 6 is a partially schematic illustration of a navigation tool in accordance with still other embodiments of the invention.

FIG. 7 is a partially schematic illustration of a navigation tool and a portion of a content set having a first display format in accordance with certain embodiments of the invention.

FIG. 8 is a partially schematic illustration of a navigation tool and a portion of the content set shown in FIG. 7 with a second display format.

FIG. 9 is a partially schematic illustration of a navigation tool in accordance with other embodiments of the invention.

FIG. 10 is a partially schematic illustration of the navigation tool shown in FIG. 8 when a cursor is no longer proximate to the navigation tool.

### DETAILED DESCRIPTION

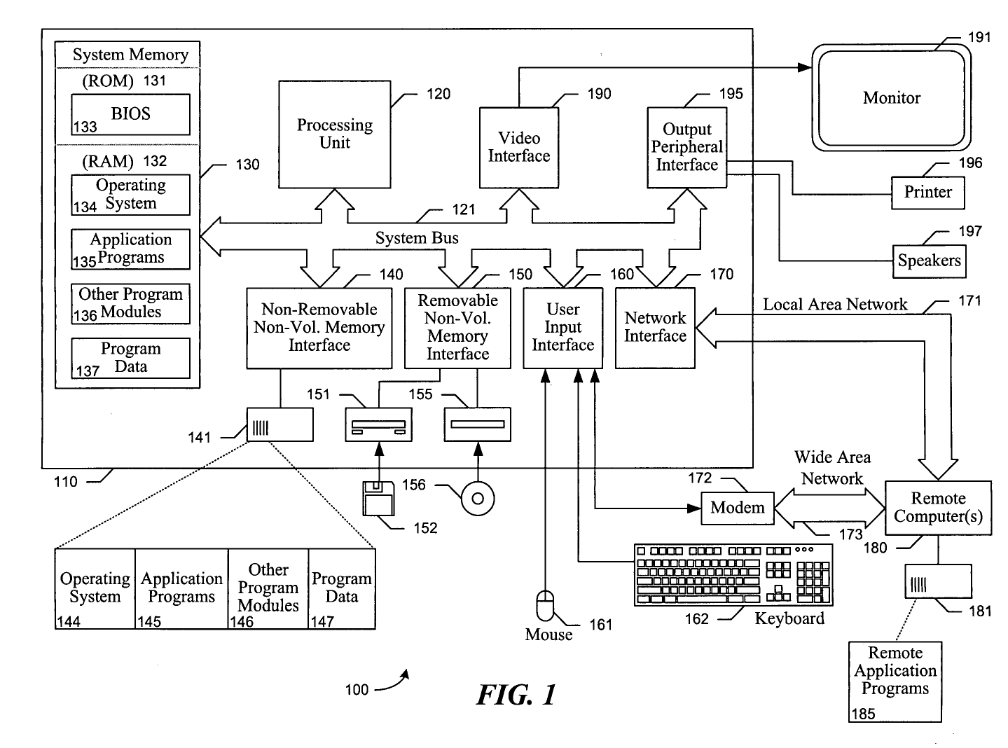

The following disclosure describes several embodiments of computer content navigation tools and associated methods. Specific details of several embodiments of the invention are described below to provide a thorough understanding of such embodiments. However, other details describing well-known structures and routines often associated with computer-based systems and methods for navigating through computer content are not set forth below to avoid unnecessarily obscuring the description of the various embodiments. Additionally, several flow diagrams and processes having process portions are described to illustrate various embodiments of the invention. It will be recognized, however, that these process portions can be performed in any order, and are not limited to the order described herein with reference to particular embodiments. Furthermore, those of ordinary skill in the art will understand that the invention may have other embodiments that include additional elements or lack one or more of the elements described below with reference to FIGS. 1-10.

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structure, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. It will be recognized that computer-readable media can store computer-executable instructions for performing at least a part of any or all process portions described herein.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements with computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port, or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

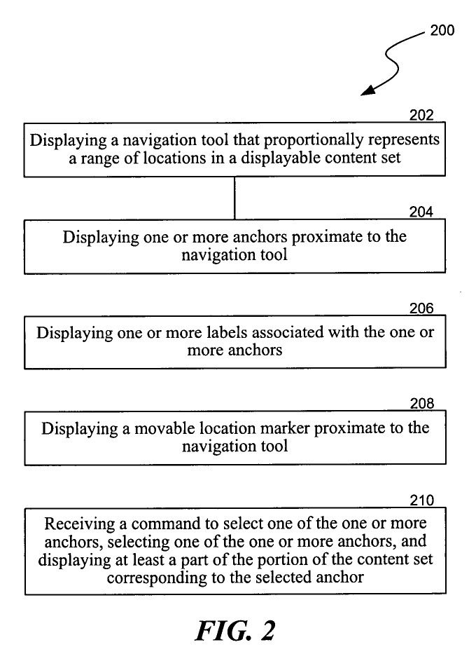

FIG. 2 illustrates a first computer-implemented process 200 for providing content navigation information. The first process 200 includes displaying a navigation tool that proportionally represents a range of locations in a displayable content set (process portion 202). For example, in certain embodiments the first process 200 can include displaying a navigation tool that proportionally represents a range of locations in a displayable content set, the content set having multiple portions, the portions each having a displayable location relative to one another. The first process 200 can further include displaying one or more anchors proximate to the navigation tool (process portion 204). For example, in certain embodiments the first process 200 can include displaying one or more anchors proximate to the navigation tool, each anchor corresponding to a portion of the content set, the position of the anchors relative to the navigation tool visually representing the displayable location of the corresponding portions relative to one another. In some embodiments, this feature can provide a user with a navigational tool that provides contextual information regarding various portions of the content set, the relative depth of information contained in the portions, and/or the position of the portions relative to one another in the content set.

In certain embodiments, the first process 200 can further include displaying the one or more anchors when a cursor is positioned proximate to the navigation tool and removing the anchors when the cursor is no longer proximate to the navigation tool. In other embodiments, the first process 200 can further include displaying one or more labels associated with the one or more anchors (process portion 206). For example, in some embodiments, the one or more labels can provide additional information about the anchors and/or the content set. In certain embodiments, the first process 200 can further include displaying one or more labels associated with the one or more anchors when a cursor is positioned proximate to the one or more anchors and removing the one or more labels when the cursor is no longer positioned proximate to the one or more anchors.

In still other embodiments, the first process 200 can further include displaying a movable location marker proximate to the navigation tool (process portion 208). For example, in certain embodiments the first process 200 can include displaying a movable location marker proximate to the navigation tool, the position of the location marker relative to the navigation tool indicating a location in the content set to be displayed. In other embodiments, the first process 200 can include displaying a movable location marker proximate to the navigation tool and highlighting the anchors proximate to the location marker. In still other embodiments, the first process 200 can include displaying a movable location marker proximate to the navigation tool, receiving a command to move the location marker to a selected position relative to the navigation tool, moving the location marker to the selected position, and displaying a part of the content set corresponding to the selected position of the location marker relative to the navigation tool. In yet other embodiments, the first process 200 can include displaying a movable location marker proximate to the navigation tool, displaying at least one navigation arrow when a cursor is positioned proximate to one or more selected areas of a display, the at least one navigation arrow being selectable to cause the location marker to move relative to the navigation tool, and removing the at least one navigation arrow when the cursor is no longer proximate to the one or more selected areas of the display. In certain embodiments, the first process 200 can include receiving a command to select one of the one or more anchors, selecting one of the one or more anchors, and displaying at least a part of the portion of the content set corresponding to the selected anchor (process portion 210).

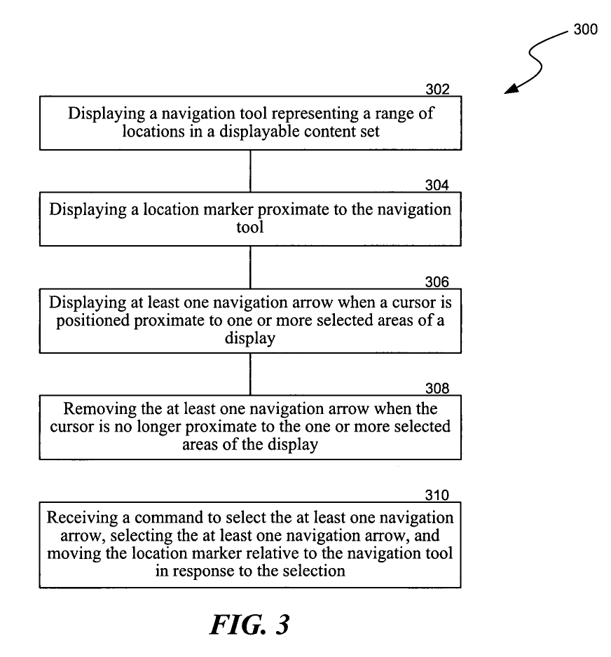

FIG. 3 illustrates a second computer-implemented process 300 for providing content navigation information. The second process 300 can include displaying a navigation tool representing a range of locations in a displayable content set (process portion 302) and displaying a location marker proximate to the navigation tool (process portion 304). For example, in certain embodiments the second process 300 can include displaying a location marker proximate to the navigation tool, the position of the location marker relative to the navigation tool indicating a location in the content set to be displayed. The second process 300 can further include displaying at least one navigation arrow when a cursor is positioned proximate to one or more selected areas of a display (process portion 306). For example, in certain embodiments the second process 300 can include displaying at least one navigation arrow when a cursor is positioned proximate to one or more selected areas of a display, the at least one navigation arrow being selectable to cause the location marker to move relative to the navigation tool. The second process 300 can still further include removing the at least one navigation arrow when the cursor is no longer proximate to the one or more selected areas of the display (process portion 308). In other embodiments, the second process 300 can further include receiving a command to select the at least one navigation arrow, selecting the at least one navigation arrow, and moving the location marker relative to the navigation tool in response to the selection (process portion 310).

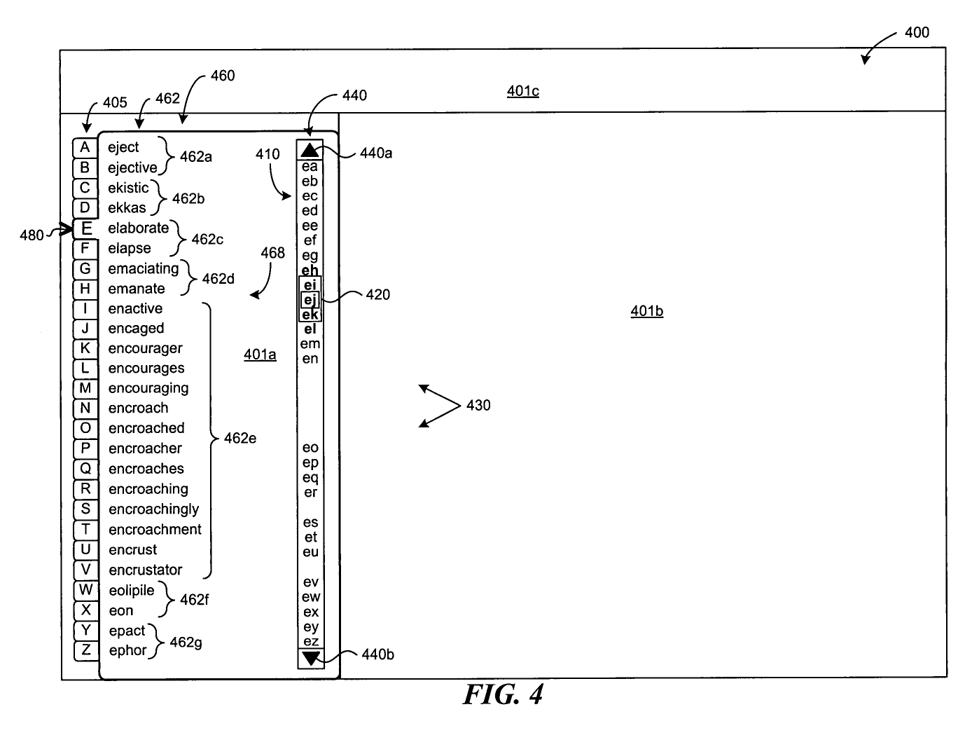

FIG. 4 is a partially schematic illustration of a display 400 with a navigation tool 410 in accordance with certain embodiments of the invention. In FIG. 4, the display includes three portions shown as a first portion 401a, a second portion 401b, and a third portion 401c. In other embodiments, the display 400 can have more or fewer portions. An index 405, a navigation tool 410, and a content set 460 are displayed in the first portion 401a of the display.

The index 405 includes lettered tabs in alphabetical order equally spaced along the left side of the first portion 401a of the display 400. In the illustrated embodiment, each tab corresponds to a displayable content set 460 (e.g., a set of displayable data or elements that can include symbols, alphanumeric characters, words, pictures, and/or figures). In FIG. 4, the tab labeled “E” has been selected as indicated by the indicator 480 to the left of the tab. Accordingly, a part 468 of a content set 460 has been displayed (e.g., a part of a list of words starting with the letter “E”). In other embodiments, a larger or smaller part of the content set 460 can be displayed, including the entire content set 460. In certain embodiments, the displayable content set 460 can be a portion of a larger set (e.g., the list of words beginning with “E” can be a portion of a larger continuous list of words beginning with “A“−”Z.” In other embodiments, the content set can be a complete list or file of data (e.g., the list of words beginning with “E” can be a separate file from words beginning with other letters).

The content set 460 can include multiple portions. In the illustrated embodiment, the portions 462 of the content set 460 correspond to portions of the word list (e.g., words beginning with the letter “E”) that begin with the same first two letters. For example, the part 468 of the content set 460 that is displayed includes seven portions, shown as a first portion 462a (words beginning with “ej”), a second portion 462b (words beginning with “ek”), a third portion 462c (words beginning with “el”), a fourth portion 462d (words beginning with “em”), a fifth portion 462e (words beginning with “en”), a sixth portion 462f (words beginning with “eo”), and a seventh portion 462g (words beginning with “ep”). The content set 460 also includes displayable portions that are not currently displayed (e.g., words beginning with “ea”-“ei” and with “eo“−”ez”), which can be displayed by paging up or down through the content set 460. As illustrated in FIG. 4, the portions 462 of the content set 460 have displayable locations relative to one another. For example, the fourth portion 462d of the content set 460 comes before the fifth portion 462e of the content set 460. Additionally, because the fourth portion 462d has fewer elements than the fifth portion 462e, the fourth portion 462d takes less room to display (e.g., takes less display area) than the fifth portion 462e.

A navigation tool 410 associated with the content set 460 has also been displayed. In the illustrated embodiment, the navigation tool 410 proportionally represents a range of locations in the displayable content set 460. For example, the navigation tool 410 can represent a continuum of all the displayable locations in the content set 460 (e.g., from the first word in the list of words beginning with the letter “E” to the last word in the list), as if the entire content set 460 were displayed at one time.

One or more anchors 430 can be displayed proximate to the navigation tool 410. In the illustrated embodiment, the anchors 430 include the first two letters of the words listed in the corresponding portions 462 of the content set 460. In other embodiments, the anchors can be displayed in other ways (e.g., using symbols, colors, textures, shading, reverse-video, alphanumeric characters, words, pictures, and/or figures). Each anchor 430 can correspond to a portion 462 of the content set 460. The position of the anchors 462 relative to the navigation tool can visually represent the displayable location of the corresponding portions 462 relative to one another. For example, in the illustrated embodiment, the “em” anchor 430 corresponds to the fourth portion 462d of the content set 460 and is positioned relative to the navigation tool 410 and relative to the other anchors 430 (e.g., “ea”-“el” and “en”-“ez”) in the same manner as the fourth portion 462d is located within the displayable content set 460 and located relative to the other portions 462.

This feature can provide a user with an indication of the location of the various portions 462 relative to one another and can also provide the user with an indication of the depth of content (e.g., the number of elements that can be displayed) of the various portions. For example, the fourth portion 462d of the content set 460 only has two words and takes up a relatively small amount of display space compared to the fifth portion 462e of the content set 460 which has 14 words. Accordingly, the “em” anchor 430 is positioned closer to the “en” anchor 430 on the navigation tool 410 than is the “eo” anchor 430.

In FIG. 4, a location marker 420 is displayed proximate to (e.g., near, over, and/or on) the navigation tool. The location marker 420 can be movable and the position of the location marker 420 relative to the navigation tool can indicate a location in the content set 460 to be displayed. For example, in the illustrated embodiment the location marker 420 is centered on the anchor 430 “ej” and the beginning of the first portion 462a (e.g., words that begin with “ej”) of the content set 460 has been placed at the top of the first display portion 401a. In FIG. 4, the anchors 430 proximate to the location marker have been highlighted (e.g., using bolded symbols, symbols that are less bold, colors, textures, shading, reverse video, and/or additional symbology). This highlighting can make it easier for a user to find the location marker.

In other embodiments, the location marker 420 can have other arrangements. For example, in certain embodiments the location in the content set corresponding to the position of the locator marker 420 can be placed in the center of the first display portion 401a instead of at the top of the first display portion 401a. In other embodiments, a portion of the navigation tool 410 proximate to the location marker 420 can be highlighted. In still other embodiments, there is no highlighting proximate to the location marker 420 and/or the location marker 420 simply includes a highlighted area on the navigation tool 410 (e.g., the highlighted area is the location marker 420). In certain embodiments, the location marker 420 can be sized so that the position of the locator marker 420 corresponds to all of the locations in the content set 460 that are to be displayed (e.g., the locator marker 420 can indicate a range of positions relative to the navigation tool 410 corresponding to the range of content set locations that are displayed). In still other embodiments, the location marker 420 can correspond to a single location and a portion of the navigation tool 410 can be highlighted to correspond to the displayed range of content set locations.

The location marker 420 can also be used to move or page through the content set 460. For example, in certain embodiments a user can select the location marker 420 and “drag” or move it to another location proximate to the navigation tool 410 (e.g., using a mouse or other pointing device). The location(s) of the content set corresponding to the new position of the location marker 420 relative to the navigation tool 410 can then be displayed. For instance, as shown in FIG. 4, if the location marker is placed proximate to the “ej” anchor 430, the beginning of the first portion 462a of the content set 460 can be placed at the top of the first display portion 401a. If the location marker 420 is placed proximate to the navigation tool 410 between the “en” and the “eo” anchors 430, the word in the fifth portion 462e, corresponding to the position of the location marker 420 relative to the navigation tool 410 can be placed at the top of the first display portion 401a.

In other embodiments, the location marker 420 can be moved relative to the navigation tool 410 using other methods. For example, in the illustrated embodiment navigation arrows 440 are displayed at the top and bottom of the navigation tool 410 (shown as a first navigation arrow 440a and a second navigation arrow 440b). In other embodiments, at least one navigation arrow 440 can be part of the navigation tool 410, attached to the navigation tool 410, and/or separate from the navigation tool 410. In certain embodiments, a user can use the navigation arrows 440 to command movement of the location marker 420. For example, in one embodiment the user can command the movement of the location marker 420 by selecting one of the navigation arrows 440 using a mouse. For instance, the user can place a cursor proximate to one of the navigation arrows and press a selected button on a mouse. If the user holds the selected button down, the location marker 420 can scroll or move continuously proximate to the navigation tool 410 in the direction indicated by the selected arrow until the selected mouse button is released. As discussed above, a part 468 of the content set 460 corresponding to the selected position of the location marker 420 relative to the navigation tool 410 can be displayed while the location marker 420 is in motion, and/or after the selected button is released and the location marker 420 has stopped moving. Similarly, if the user momentarily depresses a selected button on the mouse (e.g., “clicks” on one of the navigation arrow 440), the location marker 420 can move proximate to the navigation tool 410 in discrete increments and the corresponding parts 468 of the content set 460 can be displayed.

In other embodiments, a user can select an anchor 430 (e.g., by using a mouse to place a cursor proximate to the anchor 430 and pressing a button on the mouse), and the location marker 420 can move so that it is proximate to the anchor 430. At least a part of a portion 462 of the content set 460 corresponding to the anchor can then be displayed. In certain embodiments, if a user selects a portion of the navigation tool 410 away from an anchor, the location marker 420 can move continuously and/or move in discrete increments. For example, the location marker 420 can move continuously until it reaches the selected portion of the navigation tool 410 and/or the location marker 420 can move an incremental amount and stop until another selection is made.

In other embodiments, more or fewer navigation arrows 440 can be displayed and/or the navigation arrows 440 can have different orientations (e.g., the navigation arrows 440 can be to the left and right of a horizontally-oriented navigation tool 410). In certain embodiments, there are no navigation arrows 440 and/or no location marker 420. For example, in one embodiment a user moves through the content set 460 by selecting the anchors 430. When an anchor 430 is selected, at least a part of the corresponding portion 462 of the content set 460 is displayed. The user can determine the present location in the content set 460 by viewing the part 462 of the content set 460 that is displayed. When the user desires to move to another location in the content set 460, the user selects the anchor 430 corresponding to the desired location.

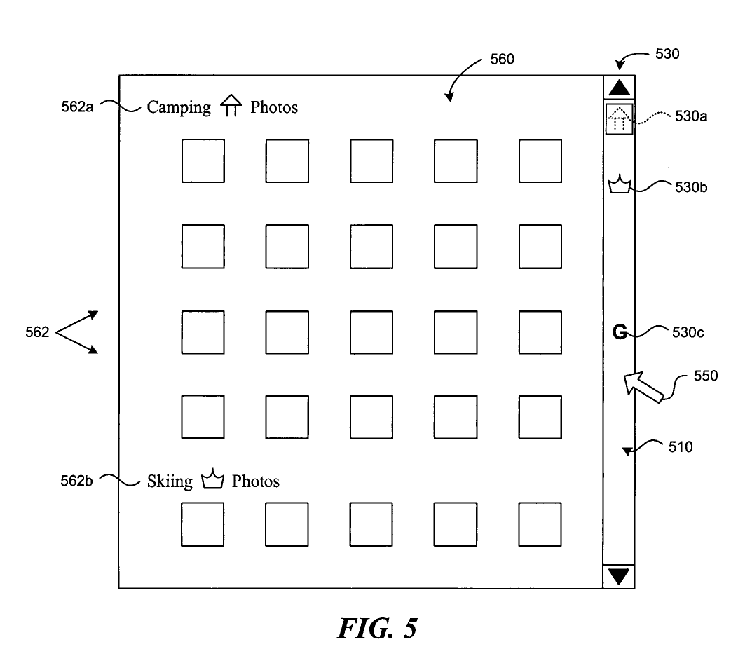

FIG. 5 is a partially schematic illustration of a navigation tool 510 and anchors 530 that include symbols. In the illustrated embodiment, a content set 560 includes photographs. A first anchor 530a corresponds to a first portion 562a (e.g., camping photos) of the content set 560. A second anchor 530b corresponds to a second portion 562b (e.g., skiing photos) of the content set 560. In the illustrated embodiment, only part of the second portion 562b is visible or currently being displayed. A third anchor 530c corresponds to a third portion of the content set 560 (not visible or currently being displayed in FIG. 5), which contains general photographs. Additionally, in FIG. 5, the anchors 530 are displayed while a cursor 550 is positioned proximate to the navigation tool 510 and removed when the cursor 550 is no longer proximate to the navigation tool 510. In certain embodiments, this feature can allow a display to be de-cluttered, but provides the user with a quick and easy way to identify the location of the portions 562 of the content set 560 and determine the relative depth (e.g., the number of photos displayed in each portion 562) of the portions 562 by displaying and examining the anchors 530.

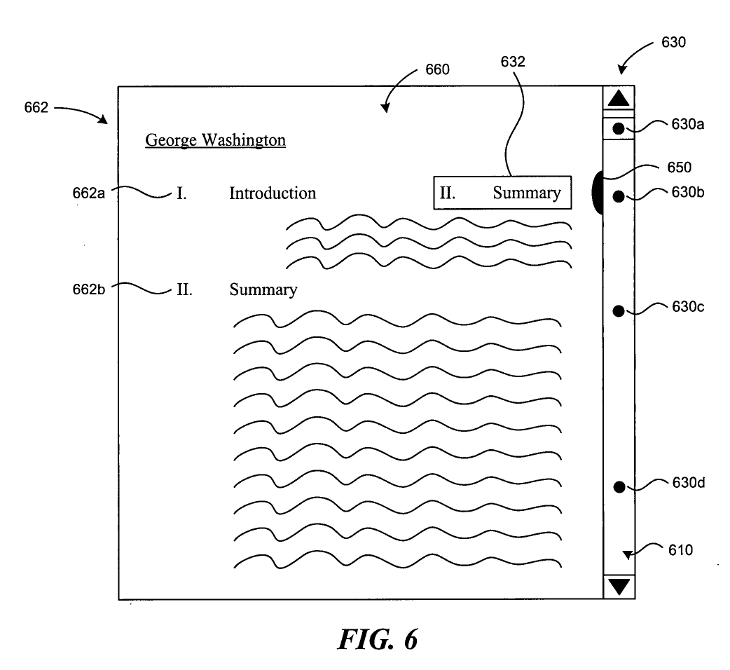

FIG. 6 is a partially schematic illustration of a navigation tool 610, one or more anchors 630, and one or more labels 632 associated with the one or more anchors 630. In the illustrated embodiment, a content set 660 includes a document and has four portions 662. In FIG. 6, only the first portion 662a and a part of the second portion 662b are currently being displayed. An anchor 630 is displayed for each of the four portions 662 of the content set 660. Accordingly, there are four anchors shown as a first anchor 630a, a second anchor 630b, a third anchor 630c, and a fourth anchor 630d. In the illustrated embodiment, when a cursor is positioned proximate to an anchor, at least one label 632 is displayed. The at least one label 632 can include information associated with the content set and/or the anchor(s). For example, in the illustrated embodiment the label 632 shows that the second anchor 630b corresponds to the second portion 662b of the content set. When the cursor is no longer proximate to the anchor, the label can be removed (e.g., no longer displayed). In certain embodiments, multiple labels can be displayed when a cursor is positioned proximate to an anchor. For example, in one embodiment associated labels appear next to all four of the anchors 630 when a cursor is positioned proximate to any one of the anchors 630 and removed when the cursor is no longer proximate to the anchors 630. In other embodiments, associated labels appear next to all four of the anchors 630 when a cursor is positioned proximate to any one of the anchors 630, but the anchor 630 proximate to the cursor is highlighted. The labels can be removed when the cursor is no longer proximate to the anchors 630. In still other embodiments, the label can include an audio message.

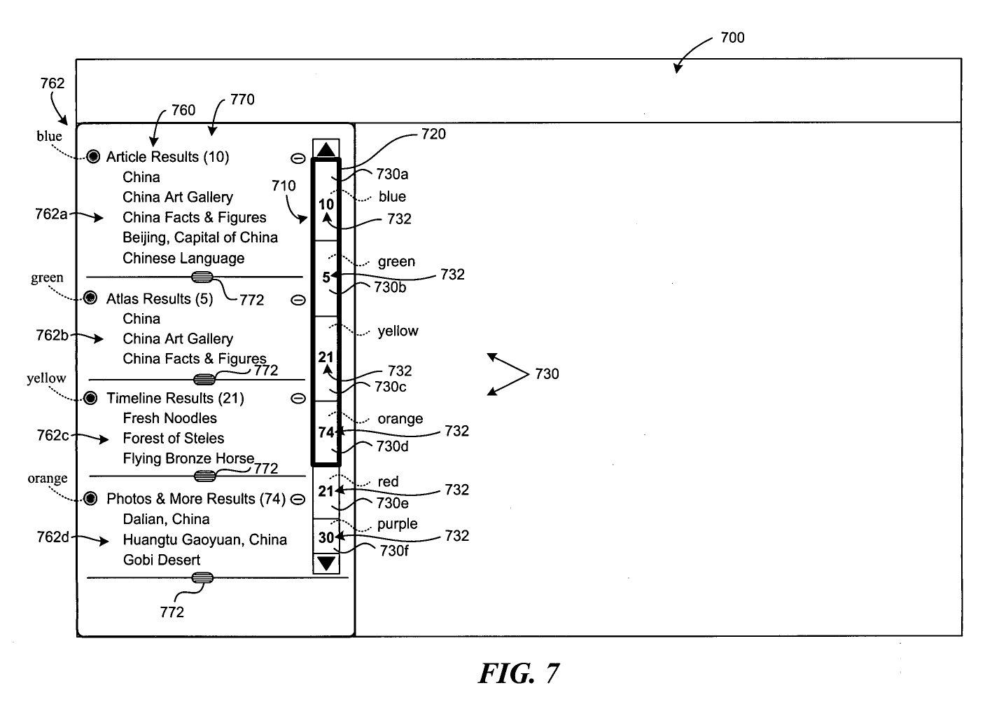

In other embodiments, labels can be displayed at other times. For example, in FIG. 7 multiple anchors 730 are shown proximate to a navigation tool 710. Each anchor 730 corresponds to a portion 762 of a content set 760. A label 732 is associated with each of the anchors 730, and is displayed whenever the associated anchor 730 is displayed. In the illustrated embodiment, the labels 732 show the number of items (e.g., related word groups or element groups) contained in each portion 762 of the content set 760. In other embodiments, more or fewer labels 732 can be displayed, labels 732 can be displayed at other times, and/or labels 732 can provide other information associated with the anchors 730, content set 760, or both.

In FIG. 7, the anchors 730 include colored bands that correspond to the multiple portions 762 of the content set 760 (e.g., the color of each anchor 730 is the same as the color used to display the corresponding content set 760). In the illustrated embodiment, each portion 762 of the content set 760 is displayed in a window 770 (e.g., a rectangular viewing area on the display 700). Each window includes a tab 772 that can be used to make the window larger or smaller (e.g., a mouse can be used to drag the tab to change the size of the window). Accordingly, various display formats can be selected by adjusting the size of the windows. In other embodiments, the display format can be altered in other ways (e.g., the window sizes can be selected in discrete increments).

In the illustrated embodiment, the size of a window can be increased to a large size where the entire content (e.g., all of the associated items and/or elements) of the corresponding portion 762 contained in the window can be displayed and viewed by a user. As the size of a window is reduced, only a part of the corresponding portion 762 is displayed to a user as the user pages through the content set 760. Accordingly, in the illustrated embodiment, the position of the anchors 730 relative to the navigation tool visually represents the displayable location of the corresponding portions 762 relative to one another based on the selected display format (e.g., the area of the display used to display the corresponding portions 762).

For example, In FIG. 7, six anchors 730 are displayed (shown as a first anchor 730a, a second anchor 730b, a third anchor 730c, a fourth anchor 730d, a fifth anchor 730e, and a sixth anchor 730f). The six anchors 730 correspond to six portions 762 of the content set 760. In FIG. 7, based on the selected display format, four portions 762 of the content set 760 are displayed (shown as a first portion 762a, a second portion 762b, a third portion 762c, and a fourth portion 762d). The size and the location of the anchors 730 relative to navigation tool and to each other correspond to the displayable size and location of the corresponding portions 762 based on the selected display format. For example, as indicated by the label associated with the fourth anchor 730d, the fourth portion 762d of the content set 760 includes 74 items, however, based on the selected display format, only three items in the fourth portion 762d are displayable (e.g., displayable without changing display formats).

In the illustrated embodiment, a location marker 720 is displayed proximate to the navigation tool 710 and is configured to indicate the range of locations of the content set 760 to be displayed. The location marker 720 is proximate to the first anchor 730a, the second anchor 730b, the third anchor 730c, and the fourth anchor 730d, indicating that their corresponding portions 762 are displayed. Correspondingly, the first portion 762a, the second portion 762b, the third portion 762c, and the fourth portion 762d are displayed.

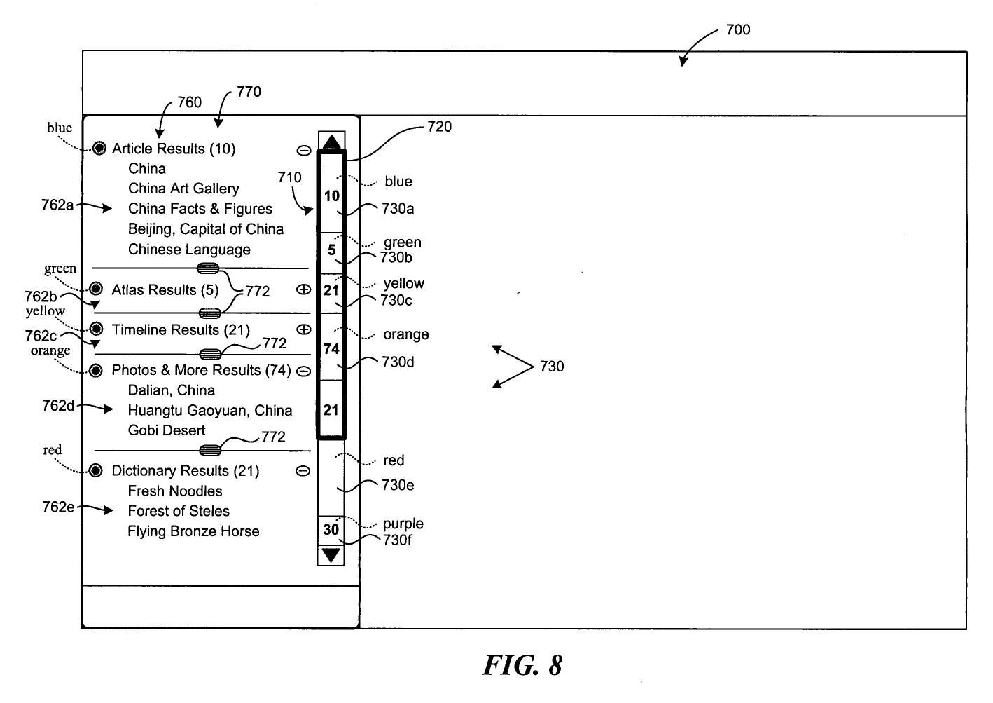

FIG. 8 is a partially schematic illustration of the display 700 shown in FIG. 7 where a different display format has been selected (e.g., some of the window sizes have been adjusted). Because the display format has changed, part of a fifth portion 762e is displayed in FIG. 8. For example, the window sizes of the second portion 762b and the third portion 762c have been reduced. Because the displayable size of the second and third portions 762b and 762c have been reduced, there is room to display at least part of the fifth portion 762e without having to page through the content set 760. Additionally, in FIG. 8, the size of the window containing the fifth portion 762e has been increased, increasing the displayable size of the fifth portion 762e. The location and size of the anchors 730 have been adjusted so that the position of the anchors 730 relative to the navigation tool 710 visually represents the displayable location of the corresponding portions 762 relative to one another based on the selected display format shown in FIG. 8.

Additionally, because part of the fifth element 762e is displayed, the location marker 720 is proximate to the first anchor 730a, the second anchor 730b, the third anchor 730c, the fourth anchor 730d, and a part of the fifth anchor 730e indicating that their corresponding portions 762 are displayed. Correspondingly, the first portion 762a, the second portion 762b, the third portion 762c, the fourth portion 762d, and a part of the fifth portion 762e are displayed. The size and location (relative to the navigation tool) of the part of the fifth anchor 730e that is proximate to the location marker 720 corresponds to the size and location (relative to the content set 760) of the part of the fifth portion 762e that is displayed.

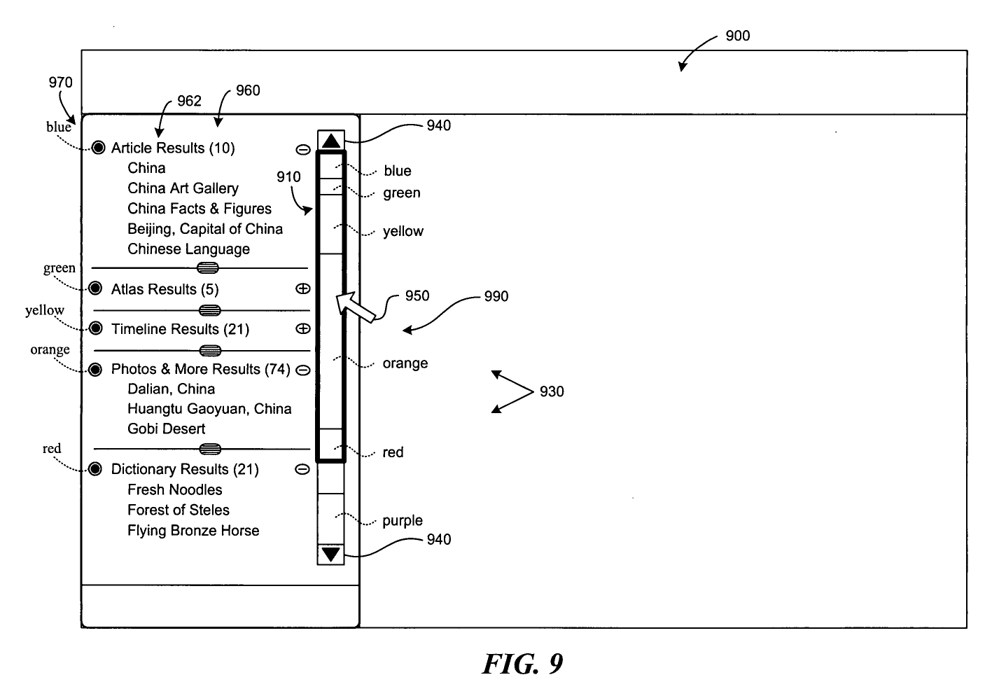

FIG. 9 is a partially schematic illustration of display 900 with a navigation tool 910 in accordance with other embodiments of the invention. In FIG. 9, the content set 960 is similar to the content set shown in FIGS. 7 and 8 and includes multiple portions 962. Each portion 962 is contained in a window 970 that can be resized. Accordingly, multiple display formats can be selected by resizing the windows 970. The anchors 930 include colored bands that correspond to the multiple portions 962 of the content set 960 (e.g., the color of each anchor 930 is the same as the color used to display the corresponding content set 960).

The anchors 930 in FIG. 9, however, are positioned proximate to the navigation tool 910 so that the position of the anchors 930 relative to the navigation tool 910 visually represents the displayable location of the corresponding portions 962 relative to one another based on a predetermined display format regardless of which display format is selected. For example, in the illustrated embodiment the displayable location of the corresponding portions 962 is a based on a displayable location that can be displayed in the predetermined format (e.g., a format that can be selected), but not necessarily based on the format that is currently selected by the user.

In the illustrated embodiment, the predetermined display format is the display format where the size of each window is increased to a large size where the entire content (e.g., all of the associated items and/or elements) of the corresponding portion 962 contained in the window can be displayed and viewed by a user. Accordingly, the size and location of each anchor 930 relative to one another represents the size and location of the portions 962 relative to one another when the predetermined display format is selected (e.g., all of the elements will be displayed and viewable as the user pages through the content set 960). In other embodiments, the displayable location of the corresponding portions 962 relative to one another can be based on a predetermined display format different than the one discussed above. In certain embodiments, this feature can provide a user with a consistent indication of the depth (e.g., amount of elements and/or items) in each portion 962, regardless of the display format that is selected.

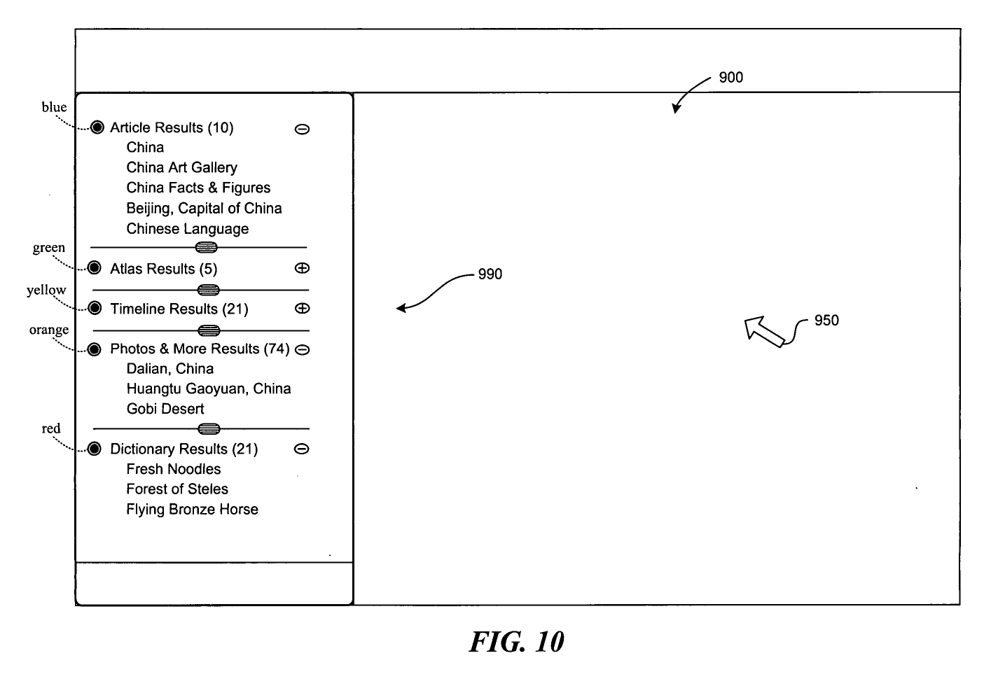

In FIG. 9, a cursor 950 is positioned proximate to an area 990 of the display 900. In the illustrated embodiment, the navigation tool 910, the anchors 930, and the navigation arrows 940 will continue to be displayed as long as the cursor 950 remains proximate to the area 990. In FIG. 10, the cursor is no longer proximate to the area 900. The navigation tool 910, the anchors 930, and the navigation arrows 940 have been removed from the display 900. In the illustrated embodiment, if the cursor 950 is later positioned proximate to the area 990, the navigation tool 910, the anchors 930, and the navigation arrows 940 will again be displayed.

In other embodiments, when the cursor 950 is no longer proximate to the area 990, the navigation tool 910 and anchors 930 are removed and replaced by a traditional scroll bar and/or a symbol indicating where the area 990 is located. In still other embodiments, when the cursor 950 is no longer proximate to the area 990, the navigation arrows 940 are removed, but the navigation tool 910 and the anchors 930 remain displayed. In certain embodiments, the area 990 is not located proximate to the navigation tool 910, and when the cursor 950 is positioned proximate to the area 990 the navigation arrows 940 appear proximate to the area 990 and are removed when the cursor 950 is no longer proximate to the area 990. In yet other embodiments, there can be multiple areas 990. For example, an area 990 can be located at each corner of the display 900. When a cursor 950 is positioned proximate to one of the areas 990, navigation arrows 940 can appear proximate to the cursor 950.

A feature of embodiments described above is that a user can be provided with a navigational tool that provides contextual information regarding various portions of the content set, the relative depth of information contained in the portions of the content set, and/or the position of the portions relative to one another in the content set. This can provide a user with a better understanding of what information is available in a content set, how the information is organized, and where one piece of information is located relative to other pieces of information. Additionally, this feature can allow the user to more quickly locate a specific piece of information contained in the content set. An advantage of this feature is that it can allow a user to search for and/or access information more effectively and efficiently. This can result in a savings of time and/or money.

From the foregoing, it will be appreciated that specific embodiments of the invention have been described herein for purposes of illustration, but that various modifications may be made without deviating from the invention. For example, aspects of the invention described in the context of particular embodiments may be combined or eliminated in other embodiments. Although advantages associated with certain embodiments of the invention have been described in the context of those embodiments, other embodiments may also exhibit such advantages. Additionally, none of the embodiments need necessarily exhibit such advantages to fall within the scope of the invention. Accordingly, the invention is not limited except as by the appended claims.

I/We claim:

1. A computer-implemented method for providing content navigation information, comprising:
displaying a navigation tool that proportionally represents a range of locations in a displayable content set, the content set having multiple portions, the portions each having a displayable location relative to one another; and
displaying one or more anchors proximate to the navigation tool, each anchor corresponding to a portion of the content set, the position of the anchors relative to the navigation tool visually representing the displayable locations of the corresponding portions relative to one another.

2. The method of claim 1 wherein the content set has two or more selectable display formats and wherein displaying one or more anchors includes displaying one or more anchors proximate to the navigation tool wherein the position of the anchors relative to the navigation tool visually represents the displayable location of the corresponding portions relative to one another based on the selected display format.

3. The method of claim 1 wherein the content set has two or more selectable display formats and wherein displaying one or more anchors includes displaying one or more anchors proximate to the navigation tool wherein the position of the anchors relative to the navigation tool visually represents the displayable location of the corresponding portions relative to one another based on a predetermined display format regardless of which display format is selected.

4. The method of claim 1, further comprising displaying a movable location marker proximate to the navigation tool, the position of the location marker relative to the navigation tool indicating a location in the content set to be displayed.

5. The method of claim 1 wherein displaying one or more anchors includes displaying multiple anchors, and wherein the method further comprises
displaying a movable location marker proximate to the navigation tool, the position of the location marker relative to the navigation tool indicating a location in the content set to be displayed; and
highlighting the anchors proximate to the location marker.

6. The method of claim 1, further comprising:
displaying a movable location marker proximate to the navigation tool, the position of the location marker relative to the navigation tool indicating a location in the content set to be displayed;
receiving a command to move the location marker to a selected position relative to the navigation tool;
moving the location marker to the selected position; and
displaying a part of the content set corresponding to the selected position of the location marker relative to the navigation tool.

7. The method of claim 1, wherein the method further comprises displaying one or more labels associated with the one or more anchors.

8. The method of claim 1, wherein the method further comprises:
displaying one or more labels associated with the one or more anchors when a cursor is positioned proximate to the one or more anchors; and
removing the one or more labels when the cursor is no longer positioned proximate to the one or more anchors.

9. The method of claim 1 further comprising:
displaying a movable location marker proximate to the navigation tool, the position of the location marker relative to the navigation tool indicating a location in the content set to be displayed;
displaying at least one navigation arrow when a cursor is positioned proximate to one or more selected areas of a display, the at least one navigation arrow being selectable to cause the location marker to move relative to the navigation tool; and
removing the at least one navigation arrow when the cursor is no longer proximate to the one or more selected areas of the display.

10. The method of claim 1 wherein displaying one or more anchors includes displaying one or more anchors when a cursor is positioned proximate to the navigation tool, and wherein the method further comprises removing the anchors when the cursor is no longer proximate to the navigation tool.

11. The method of claim 1 wherein displaying a navigation tool and displaying one or more anchors include displaying a navigation tool and displaying one or more anchors when a cursor is positioned proximate to one or more selected areas of a display, and wherein the method further comprises removing the navigation tool and the one or more anchors when the cursor is no longer proximate to the one or more selected areas of the display.

12. The method of claim 1, further comprising:
receiving a command to select one of the one or more anchors;
selecting the one of the one or more anchors; and
displaying at least a part of the portion of the content set corresponding to the selected anchor.

13. A computer-implemented method for providing content navigation information, comprising:
displaying a navigation tool representing a range of locations in a displayable content set;
displaying a location marker proximate to the navigation tool, the position of the location marker relative to the navigation tool indicating a location in the content set to be displayed;
displaying at least one navigation arrow when a cursor is positioned proximate to one or more selected areas of a display, the at least one navigation arrow being selectable to cause the location marker to move relative to the navigation tool; and
removing the at least one navigation arrow when the cursor is no longer proximate to the one or more selected areas of the display.

14. The method of claim 13, further comprising:
receiving a command to select the at least one navigation arrow;
selecting the at least one navigation arrow; and
moving the location marker relative to the navigation tool in response to the selection.

15. A computer-readable medium having computer-executable instructions for performing steps comprising:
displaying a navigation tool that proportionally represents a range of locations in a displayable content set, the content set having multiple portions, the portions each having a displayable location relative to one another; and
displaying one or more anchors proximate to the navigation tool, each anchor corresponding to a portion of the content set, the position of the anchors relative to the navigation tool visually representing the displayable locations of the corresponding portions relative to one another.

16. The computer-readable medium of claim 15 wherein the steps further comprise displaying a movable location marker proximate to the navigation tool, the position of the location marker relative to the navigation tool indicating a location in the content set to be displayed.

17. The computer-readable medium of claim 15 wherein the steps further comprise displaying one or more labels associated with the one or more anchors.

18. The computer-readable medium of claim 15 wherein the steps further comprise:
receiving a command to select one of the one or more anchors;
selecting the one of the one or more anchors; and
displaying at least a part of the portion of the content set corresponding to the selected anchor.

19. The computer-readable medium of claim 15 wherein the steps further comprise:
displaying a movable location marker proximate to the navigation tool, the position of the location marker relative to the navigation tool indicating a location in the content set to be displayed;
displaying at least one navigation arrow when a cursor is positioned proximate to one or more selected areas of a display, the at least one navigation arrow being selectable to cause the location marker to move relative to the navigation tool; and
removing the at least one navigation arrow when the cursor is no longer proximate to the one or more selected areas of the display.

20. The computer-readable medium of claim 15 wherein the step of determining displaying one or more anchors includes displaying one or more anchors when a cursor is positioned proximate to the navigation tool, and wherein the steps further comprise removing the anchors when the cursor is no longer proximate to the navigation tool.
